(19) United States
(12) Patent Application Publication
(10) Pub. No.: US 2005/0114058 A1
(43) Pub. Date: May 26, 2005

(54) Method for analyzing inspected data, apparatus and its program

(76) Inventors: Makoto Ono, Yokohama (JP); Junko Konishi, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/981,661

(22) Filed: Nov. 5, 2004

(30) Foreign Application Priority Data
Nov. 7, 2003 (JP) 2003-377735

(51) Int. Cl. G06F 19/00

(52) U.S. Cl. 702/83

(57) ABSTRACT

An inspected data analysis method, apparatus, and program for analyzing inspected data using an information processing unit. The program embodies the method, and, when it is run, causes the apparatus to execute reading processing for reading from a storage device inspected data including a plurality of measurement items measured at a plurality of locations of a plurality of objects under inspection, processing for testing a significant difference of the inspected data at each measuring location for each measurement item, and processing for selecting measurement items based on the significant difference, and displaying inspected data for each of the selected measurement items on a display device.

### INCORPORATION BY REFERENCE

The present application claims priority from Japanese application JP2003-377735 filed on Nov. 7, 2003, the content of which is hereby incorporated by reference into this application.

### BACKGROUND OF THE INVENTION

The present invention relates to a method for analyzing inspected data of thin-film devices, represented by integrated circuits on a semiconductor wafer, liquid crystal display modules, and thin-film magnetic heads for magnetic recording devices, using an information processing unit, an apparatus, and its program.

An integrated circuit will be described below as an representative example of thin-film devices.

Processes for manufacturing integrated circuits is generally classified into front-end processes for fabricating circuits formed in chips (dies) on a silicon wafer, and post-processes for dicing the respective chips and finishing them into products.

Generally, each chip is checked whether it passes or fails in an electric characteristic inspection performed using a tester at the end of the front-end processes, and only chips determined as non-defective are sent to the post-processes.

The electric characteristic inspection performed at the end of the front-end processes generally includes not only a bin inspection for measuring characterized of respective chips, but also a TEG inspection for measuring characteristics of a thin-film process in the front-end processes.

The bin inspection can measure an operating frequency and power consumption of each chip itself, but cannot measure how respective transistors operate.

Therefore, the TEG inspection is performed to monitor whether or not a thin-film process can correctly form transistors, and the like.

The TEG inspection involves the formation of a variety of test element groups in crevices such as between chips, not the chips themselves, i.e., TEG (Test Element Group) for measuring their device characteristics. For example, when a circuit pattern is formed only of simple wires as TEG for measuring the resistance thereof, it can be found whether or not the circuit pattern can be formed with correct line widths. Also, a transistor is formed as TEG for measuring a current value and a voltage value with which the transistor correctly operates. The TEG inspection generally measures several tens to several hundreds of characteristic items. Also, the same items under measurement are measured at several locations within a wafer surface for calculating an average which is used as a representative value of the wafer.

As described in JP-A-2002-24204, JP-A-2002-124445, JP-A-2000-223538, “Statistical Micro Yield Modeling” written by Allan Y. Wong, Semiconductor International, pp.139, 140, 142, 144, 146, 148, 1996, “A Statistical Method for Reducing Systematic Defects in the Initial Stages of Production” written by Nemoto et al., Proceedings of IEEE/SEMI Advanced Semiconductor Manufacturing Conference and Workshop, pp.77-81, 2002, and the like, the result of such a TEG inspection is utilized as a clue for improving the yield by corresponding a yield found by the bin inspection to inspected data of each item under measurement in the TEG inspection, and narrowing down to defective items under measurement through a correlation analysis or the like.

Certainly, the foregoing method is effective for thin-film devices which are low in integration degree.

However, integrated circuits which have been increasingly more complicated in recent years have created a situation in which the bin inspection cannot be said to be always credible. A thorough inspection on integrated circuits for each and every states would require a long time and double an inspection cost. A bin inspection performed within a limited time would fail to reliably find defects and let defective products be shipped to customers.

For solving such problems, a mechanism is required not only for analyzing the correlation between inspected data in the TEG inspection and the yield but also for managing variations in TEG inspected data and reducing the variations.

Also, variations in other inspected data are similarly problematic.

### SUMMARY OF THE INVENTION

It is an object of the present invention to provide a technique for quantifying variations in inspected data to automatically narrow down to inspection items which present awful variations.

The present invention provides a program which is executed to quantify variations in inspected data, using a difference among measuring points within a wafer surface to automatically find an inspection item which presents a large difference.

Specifically, the present invention provides an inspected data analysis program for analyzing inspected data using an information processing unit. The program performs reading processing for reading from a storage device inspected data including a plurality of measurement items measured at a plurality of locations of a plurality of objects under inspection, processing for testing a significant difference of the inspected data at each measuring location for each measurement item, and processing for selecting measurement items based on the significant difference, and displaying inspected data for each of the selected measurement items on a display device.

According to the present invention, a data analysis can be rapidly and efficiently executed for reducing defective thin-film devices. This can improve the yield and reduce defective products shipped to customers.

Other objects, features and advantages of the invention will become apparent from the following description of the embodiments of the invention taken in conjunction with the accompanying drawings.

### BRIEF DESCRIPTION OF THE DRAWINGS

FIG. 1 is flow chart illustrating an exemplary characteristic data analysis process;

FIG. 2 is block diagram illustrating the configuration of exemplary hardware;

FIG. 3 shows exemplary inspected data;

FIG. 4 shows measuring points indicated on a wafer by way of example;

FIG. 5 is an exemplary conceptual diagram representing a calculation of a P-value for each item under measurement;

FIG. 6 shows an exemplary output screen;

FIG. 7 shows another exemplary output screen;

FIG. 8 is a conceptual diagram showing an example of how a fault is notified;

### DESCRIPTION OF THE EMBODIMENTS

The following description will be made using an example of analysis made on inspected data from a TEG inspection performed on a semiconductor wafer, as an example of thin-film device, using a tester.

It should be understood that the present invention can also be applied to inspected data of other testers, and is not limited to the following embodiment.

### First Embodiment

In the following, a first embodiment of the present invention will be described with reference to the accompanying drawings.

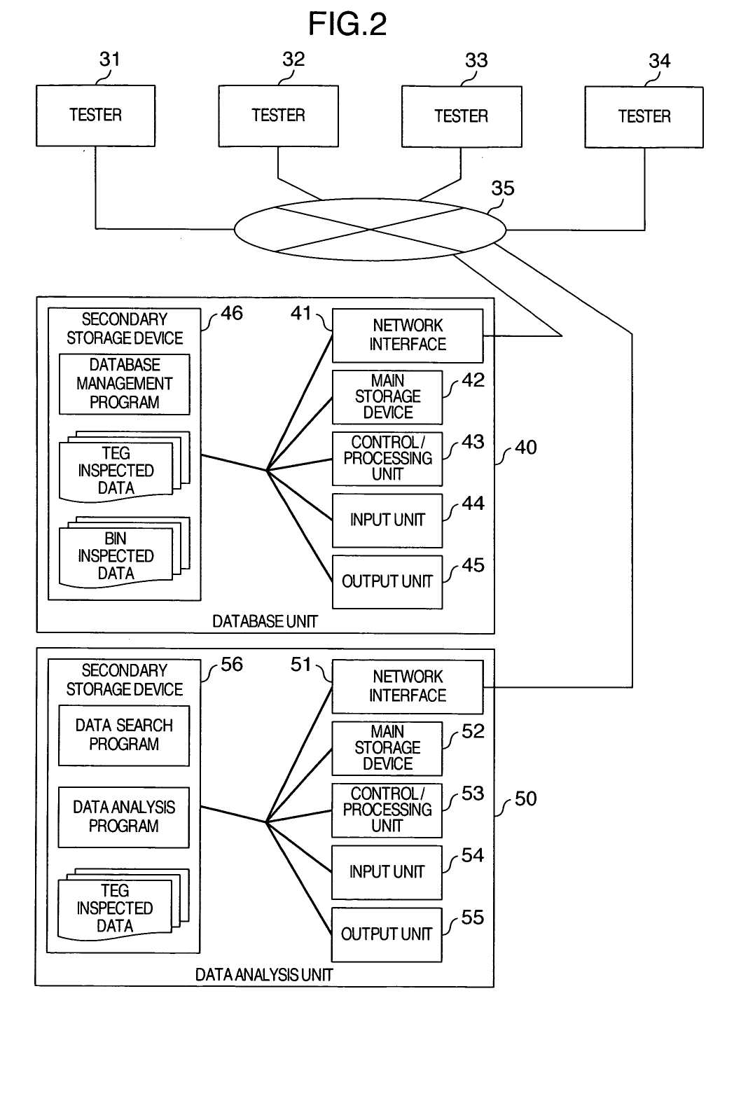

FIG. 2 illustrates the configuration of exemplary hardware for executing a program of the present invention.

Testers (electric characteristic inspection apparatuses) 31, 32, 33, 34, a database unit 40, and a data analysis unit 50 are interconnected through a local area network 35 for communicating data therebetween.

The database unit 40 is a computer which is connected to the local area network 35 through a network interface 41, and has a main storage device 42, a control/processing unit 43, an input unit 44, an output unit 45, and a secondary storage device 46.

The secondary storage device 46 stores a database management program, data of TEG inspections and data of bin inspection collected from the testers 31, 32, 33, 34.

The data analysis unit 50 is a computer which is connected to the local area network 35 through a network interface 51, and has an information processing unit (including a main control device 52, a control/processing unit 53), an input unit (a keyboard or a mouse) 54, an output unit (a display device) 55, and a secondary storage device 56.

The second storage device 56 stores a data search program executed for searching inspected data of TEG intended for analysis and collecting the data into the database unit 40, and an inspected data analysis program.

When the inspected data analysis program is executed, the data of TEG inspection stored in the database unit 40 is collected and stored in the secondary storage device 56 through the local area network 35.

While this example shows four testers in FIG. 2, the number of testers is not limited to four. Also, while the database unit 40 and data analysis unit 50 are described as different computers, both functions may be integrated into a single computer.

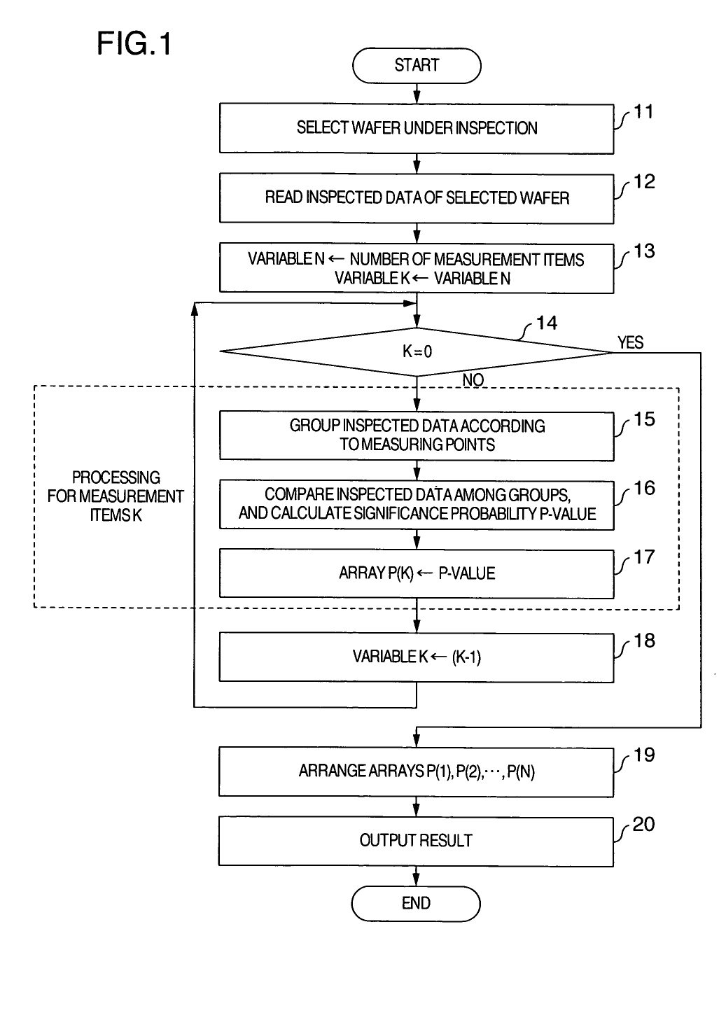

FIG. 1 is a flow chart illustrating an exemplary processing procedure of the program according to the present invention.

First, at step 11, a plurality of wafers are specified for inspection. While wafers may be specified by specifying the date and time at which a wafer has passed the inspection process, or specifying a lot ID or a wafer ID, wafers are specified herein by entering information with which inspected data can be identified for the plurality of wafers.

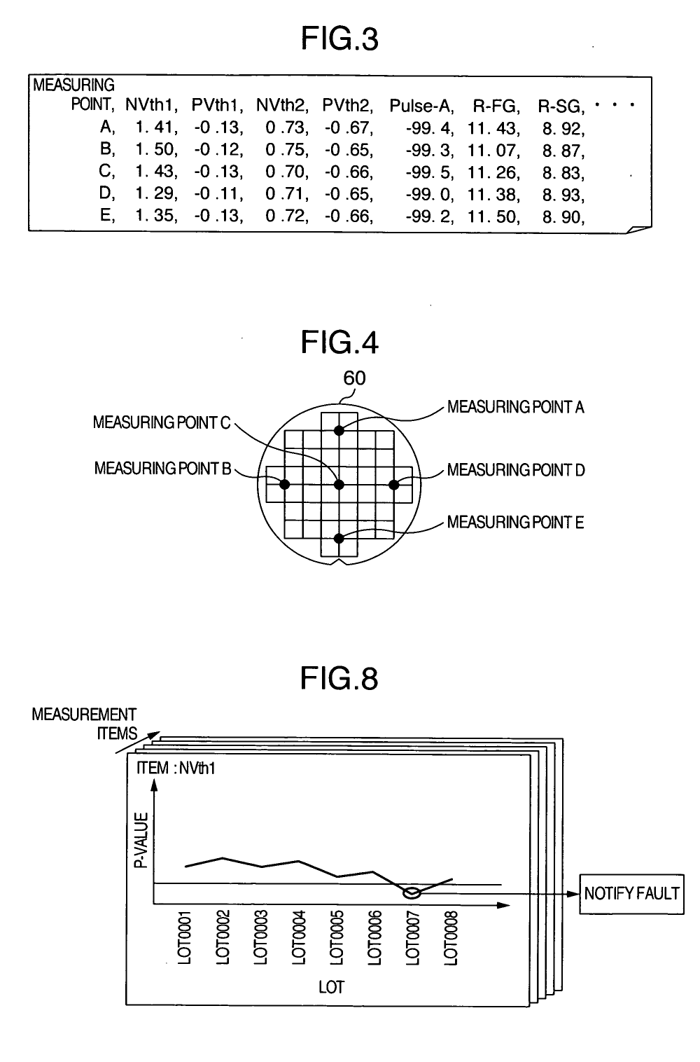

Next, at step 12, inspected data resulting from the TEG inspection performed on the wafers specified at step 11 are read. In this example, the data search program previously stored in the secondary storage device 56 is activated from this program to search the database unit 40 for inspected data of interest which is then collected. FIG. 3 shows exemplary inspected data for a certain wafer. In this example, a large number of measurement items are measured at five measuring points A-E on the one wafer, including a threshold voltage NVth1 of an n-channel of a transistor, a threshold voltage PVth1 of the n-channel of the transistor, and a threshold voltage NVth2 of the n-channel of the transistor. Though not shown, a table of this inspected data additionally includes data used for specifying wafers at step 11, such that the data search program makes a search using the data as a key. Measurement items and measuring points may vary depending on the semiconductor manufacturer, factory, type, and the like, and are not limited to five measuring points or the foregoing exemplary measurement items. In this example, measuring points as shown in FIG. 4 are included in a wafer. A circle 60 represents a wafer, and a large number of white rectangles represent respective chips. Five black circles indicate measuring points in the TEG inspection.

Next, at step 13, the number of measurement items included in the read inspected data is defined to be N, the number of times of remaining tests is defined to be K, and its initial value is set to N in preparation for determining whether or not a significant difference test is repeated.

Next step 14 provides conditional branches. If the number K of times of remaining tests is zero (K=0), the test is not repeated, and the program proceeds to step 19. If K≠0, the program proceeds to step 15 for repeating the test.

When the program proceeds to step 15, step 15 to step 17 are sequentially executed. Processing at each of step 15 to step 17 is executed for a measurement item associated therewith. For example, processing for the item NVth1 in FIG. 3 is performed when K=1; processing for PVth1 in FIG. 3 when K=2; and processing for NVth2 in FIG. 3 when K=3.

At step 15, the inspected data is grouped according to the measuring points. The grouping according to the measuring points involves classifying data on measurement items in the inspected data for each wafer shown in FIG. 3 according to the measuring points A to E, and collecting the data at each measuring point of all wafers of interest into one group.

Specifically, each group includes data on the number of wafers specified at step 11. Also, since there are five measuring points in this example, there are five groups A-E.

At step 16, the inspected data are compared among the groups. In this event, a statistical test is performed to calculate significance probability P-value. The significant probability P-value enables comparisons among the measurement items even though the respective measurement items are represented in different units. The statistical test may involve finding an F-value by analysis of variance, calculating the P-value in accordance with an F distribution, or performing a t-test, and calculating the P-value. In the present invention, any method may be applied.

At step 17, the P-value calculated at step 16 is substituted into an array P(K).

At step 18, the value of the variable K is decremented by one, followed by the program returning to step 14.

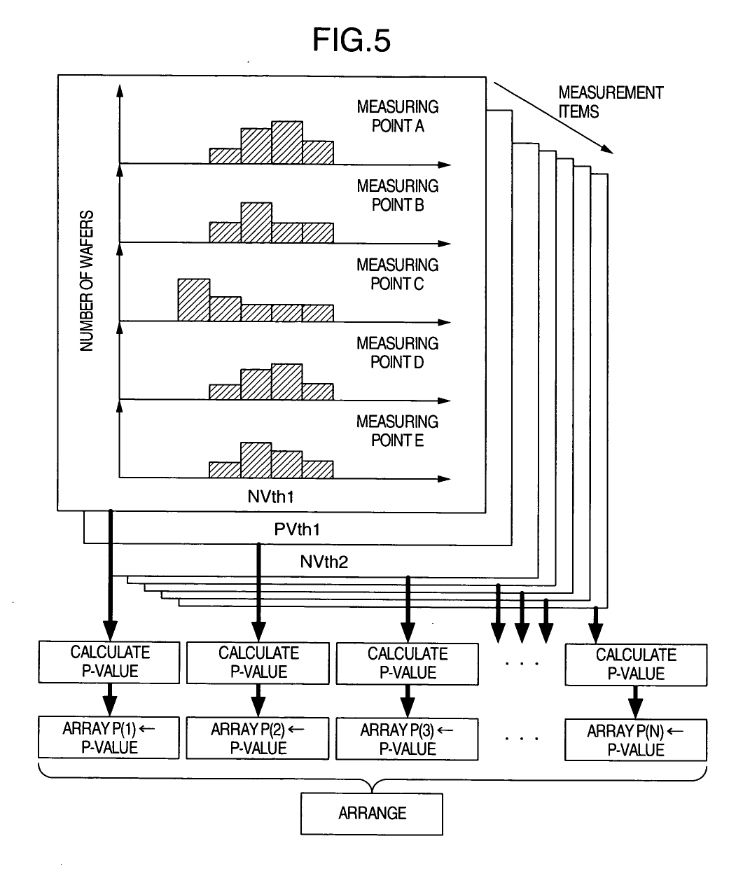

FIG. 5 shows an exemplary representation of the processing at step 14 to step 18. Histograms for the respective measuring points are compared for each measurement item, and a statistical difference among the histograms is calculated as the P-value, and the P-value is substituted into the array P(K).

When the program takes a path to step 19 at the conditional branch of step 14, the P-value for each measurement item has been substituted into each of the arrays P(1) to P(N).

Next, at step 19, the contents of the array are sorted in order from the smallest one.

Finally, the result is outputted at step 20.

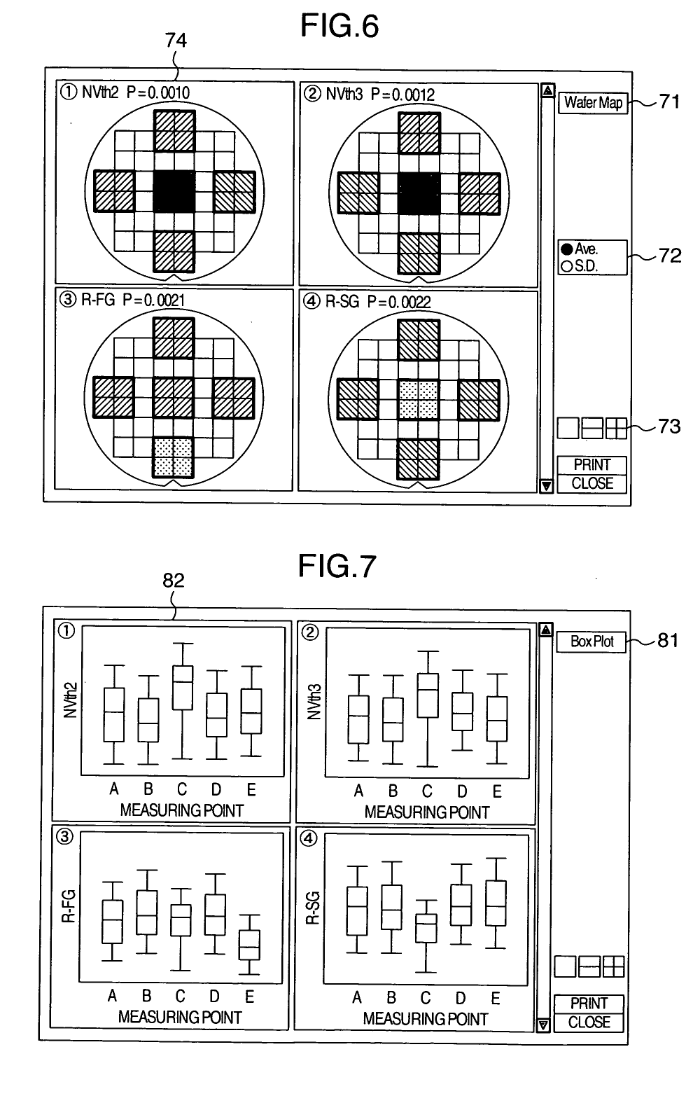

FIG. 6 shows an exemplary output screen of the result. This screen is an example of GUI (graphical User Interface) outputted to the output unit 55. An output method is selected on a pull-down menu 71. In the shown example, “Wafer Map” is selected. At a selector 72, a selection is made as to whether to output the average value “Ave.” or standard deviation “S.D” of the inspected data grouped at step 15. In this example, the average value is selected. At a selector 73, a screen display method is selected. In the shown example, the screen is divided into four to display four measurement items at one time. A display area 74 shows an exemplary display of the result. In this example, “NVth2” is automatically detected as the measurement item having the smallest P-value. The measurement item having the second smallest P-value is “NVth3,” and the measurement item having the third smallest P-value is “R-FG.” The display area 74 shows the average value of the inspected data for each measuring point on the wafer in contrast. In this figure for example, measurement points are located in the center of the semiconductor chip, light and shade of average of the inspection data at the measuring points are displayed by way of light and shade at the center of the four semiconductor chips. Specifically, in the measurement item “NVth2,” the center of wafer is displayed in the deepest contrast. This means that the average value of the inspected data measured by TEG at the center of the wafer is larger than other measuring points.

In this way, for displaying how each measurement item varies at the respective measuring points, the measurement items are selected in order from the one having the smallest significance probability based on the significance probability, which is the significant difference of the inspected data, and the measurement items are arranged in this order on the display, thereby permitting the operator (person in charge of analysis) to know how the inspection items vary in a readily understandable manner.

Also, the inspected data is displayed on the display device in a display format which permits the operator to visually identify the significant difference for each measuring point, i.e., in a display mode which can represent a change in brightness or color saturation (contrasting or color-coding) or a box plot, described below, thus permitting the operator (person in charge of analysis) to know which measuring location presents large variations in a readily understandable manner.

FIG. 7 shows another exemplary output screen of the result, in which a box plot is selected on a pull-down menu 81. A display area 82 shows an exemplary display of the result. The display area 82 presents a box plots which takes the measuring point on the horizontal axis, and measurement items on the vertical axis. Since this example simply employs a different display method from that of FIG. 6, the measurement item having the smallest P-value, the measurement item having the second smallest P-value, and the like are the same as those in FIG. 6. Like FIG. 6, it can be seen that the value of the measurement data at measuring point C is larger than the other measuring points.

As described above, with the program of the present invention, the operator of this system, i.e., the person in charge of analysis, can narrow down to a measurement item or a measuring location which is closely related to the cause of defective characteristic.

Specifically, it can be seen in the examples of FIGS. 6, 7, that the item which is most closely related to the defective characteristic is “NVth2,” and the second is “NVth3.” As a result, the person in charge of analysis, who views the display, can take action of analyzing “why the inspected data of the measurement item “NVth2” differs among the measuring points on the wafer.”

When a table is provided for corresponding each of measurement items to a manufacturing process and/or a manufacturing device which affect the item, a manufacturing process and/or a manufacturing device, which can cause defects, can be identified with a key set to the measurement item having the largest significant difference of inspected data.

### Second Embodiment

The first embodiment has shown an example in which the program is executed on a periodic basis when TEG inspected data has been accumulated for a certain number of wafers. On the other hand, the program of the present invention can be executed for each lot at all times to monitor the lot for defects.

FIG. 8 shows an exemplary change in the P-value calculated between the measuring points for each measurement item and for each lot. If a calculated P-value is smaller than a previously set threshold, the person in charge is notified of a defective lot and measurement item. In this way, it is possible to reduce the probability of sending defective products to customers using not only the bin inspection but also the TEG inspection.

While the foregoing embodiments have been described in connection with inspected data on electric characteristics measured by testers, this analysis can also be effectively applied to inspected data of other testers such as a length SEM (Scanning Electron Microscope) and the like.

It should be further understood by those skilled in the art that although the foregoing description has been made on embodiments of the invention, the invention is not limited thereto and various changes and modifications may be made without departing from the spirit of the invention and the scope of the appended claims.

1. An inspected data analysis program for analyzing inspected data using an information processing unit, comprising:
reading processing for reading from a storage device inspected data including a plurality of measurement items measured at a plurality of locations of a plurality of objects under inspection;
processing for testing a significant difference of the inspected data at each measuring location for each measurement item; and
processing for selecting measurement items based on the significant difference, and displaying inspected data for each of the selected measurement items on a display device.

2. An inspected data analysis program for analyzing inspected data using an information processing unit, comprising:
reading processing for reading from a storage device inspected data including a plurality of measurement items measured at a plurality of locations of a plurality of objects under inspection;
processing for testing a significant difference of the inspected data at each measuring location for each measurement item; and
processing for displaying the inspected data for each measurement item relying on the significant difference for determining an order in which the inspected data are displayed or positions at which the inspected data are displayed on a display device, or displaying the inspected data on the display device in a display format with which the significant difference can be visually identified for each measuring location.

3. An inspected data analysis program for analyzing inspected data using an information processing unit, comprising:
reading processing for reading from a storage device inspected data including a plurality of measurement items measured at a plurality of locations of a plurality of objects under inspection;
processing for testing a significant difference of the inspected data at each measuring location for each measurement item, and normalizing the significant difference; and
processing for comparing the normalized significant difference with a previously defined threshold to sense a fault based on a magnitude relationship.

4. An inspected data analysis program according to claim 1, wherein:
said object under inspection is a wafer including a test element group; and
the inspected data comprises electric characteristic data measured by a tester for the test element group.

5. An inspected data analysis program according to claim 1, wherein:
said object under inspection is a wafer including a test element group; and
the inspected data comprises electric characteristic data measured by a tester for the test element group.

6. An inspected data analysis program according to claim 3, wherein:
said object under inspection is a wafer including a test element group; and
the inspected data comprises electric characteristic data measured by a tester for the test element group.

7. An inspected data analysis program according to claim 1, wherein:
said normalized significant difference is a significance probability.

8. An inspected data analysis program according to claim 2, wherein:
said normalized significant difference is a significance probability.

9. An inspected data analysis program according to claim 3, wherein:
said normalized significant difference is a significance probability.

10. An inspected data analyzer for analyzing inspected data, connected to:
a plurality of characteristic testers each for performing a plurality of items of characteristic inspections on a predetermined object under inspection, and
a database unit for storing inspected data inspected by said plurality of characteristic testers for each of said characteristic tester correspondingly, through a network wherein said analyzer comprising;
a data analysis unit for reading the inspected data stored for each of said plurality of characteristic testers from said database unit, testing a significant difference of the inspected data at each measuring location for each measurement item, selecting measurement items based on the significant difference, and displaying the inspected data for each of the selected measurement items on a display device.

11. An inspected data analyzer for analyzing inspected data according to claim 10, wherein:
said data analysis unit displays the inspected data for each measurement item, relying on the significant difference for determining an order in which the inspected data are displayed or positions at which the inspected data are displayed on the display device, or displays the inspected data on the display device in a display format with which the significant difference can be visually identified for each measuring location.
